(19) United States
(12) Patent Application Publication
(10) Pub. No.: US 2010/0261010 A1
(43) Pub. Date: Oct. 14, 2010

(54) MULTI-LAYER FILM AND ELECTRONIC DEVICE SHELL HAVING SAME

(75) Inventors: CHAO-TSANG WEI, Tu-Cheng (TW); GA-LANE CHEN, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/543,605

(22) Filed: Aug. 19, 2009

(30) Foreign Application Priority Data
Apr. 13, 2009 (CN) 200910301504.6

(51) Int. Cl. B32B 15/04

(52) U.S. Cl. 428/336; 428/457; 428/450; 428/469

(57) ABSTRACT

An exemplary multi-layer film includes a light absorbing layer, a number of metallic layers formed on the light absorbing layer, and a number of transparent medium layers each sandwiched between two respective adjacent of the metallic layers. Each of the metallic layers is configured for reflecting part of light incident thereon to be a reflected light and transmitting another part of the incident light therethrough. The light absorbing layer is capable of absorbing light incident thereon. The medium layers are configured for controlling light path differences between the reflected lights thereby allowing the reflected lights to interfere with each other and provide the multi-layer film with a desired color appearance.

### CROSS-REFERENCE TO RELATED APPLICATIONS

This application is related to commonly-assigned co-pending applications entitled, “MULTI-LAYER FILM STRUCTURE WITH MEDIUM LAYER,” (Atty. Docket No. US24328), and “MULTI-LAYER FILM AND ELECTRONIC DEVICE SHELL WITH SAME,” (Atty. Docket No. US24274). The above-identified applications are filed simultaneously with the present application. The disclosures of the above-identified applications are incorporated herein by reference.

### BACKGROUND

1. Technical Field

The present invention relates to multi-layer films, and particularly, to a colored multi-layer film, and an electronic device shell coated with the multi-layer film.

2. Description of Related Art

Colored shells are widely used in electronic devices, such as mobile phones. Currently, the coloration of such shells is usually produced by painting. However, many paints are not environmentally friendly. For example, some paints or by-products thereof can be harmful to humans. Furthermore, many painted surfaces are not wear-resistant and are easily scratched.

What is needed, therefore, is a film and an electronic device shell coated with the film, which can overcome the above-described shortcomings.

### BRIEF DESCRIPTION OF THE DRAWINGS

Many aspects of the present multi-layer film and electronic device shell can be better understood with reference to the following drawings. The components in the drawings are not necessarily drawn to scale, the emphasis instead being placed upon clearly illustrating the principles of the present multi-layer film and electronic device shell. Moreover, in the drawings, all the views are schematic, and like reference numerals designate corresponding parts throughout the views.

FIG. 1 is a cross-sectional view of a multi-layer film formed on a substrate in accordance with a first embodiment.

FIG. 2 is a cross-sectional view of a multi-layer film formed on a substrate in accordance with a second embodiment.

FIG. 3 is a cross-sectional view of an electronic device shell in accordance with a third embodiment.

### DETAILED DESCRIPTION OF EMBODIMENTS

Various embodiments of the present multi-layer film and electronic device shell will now be described in detail below and with reference to the drawings. In this description, unless the context indicates otherwise, a reference to “light” includes a reference to a light beam or light beams.

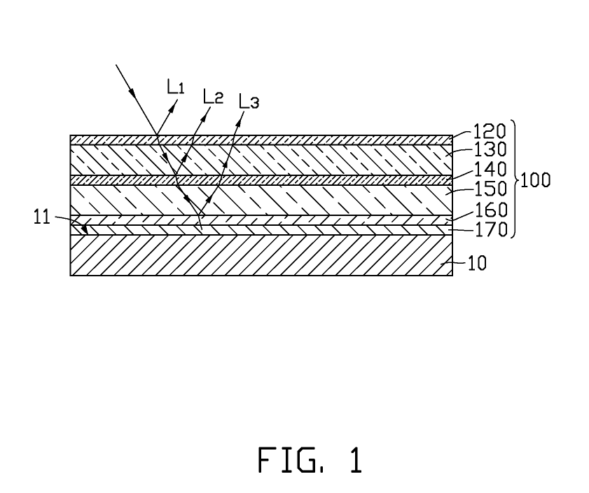

Referring to FIG. 1, an exemplary multi-layer film 100 in accordance with a first embodiment is shown. The multi-layer film 100 includes in sequence a first metallic layer 120, a first medium layer 130, a second metallic layer 140, a second medium layer 150, a third metallic layer 160, and a light absorbing layer 170. The first metallic layer 120, first medium layer 130, second metallic layer 140, second medium layer 150, third metallic layer 160 and the light absorbing layer 170 have top surfaces and bottom surfaces parallel to each other. The light absorbing layer 170 is configured to cling (adhere) to a surface 11 of a substrate 10. In this description, the combination of the multi-layer film 100 and the substrate 10 is referred to as a “multi-layer film structure.”

The first metallic layer 120, the second metallic layer 140, and the third metallic layer 160 each contain a material selected from a group consisting of aluminum, nickel, chromium, and alloy of nickel and chromium. Preferably, the first metallic layer 120, the second metallic layer 140, and the third metallic layer 160 are made of the same material, and thus have the same reflection capability and refraction capability. A thickness of each of the first metallic layer 120, the second metallic layer 140 and the third metallic layer 160 is in a range from 0.3 nanometers (nm) to 200 nm. The first metallic layer 120 is capable of reflecting part of incident light (e.g., visible light which includes red, orange, yellow, green, blue, indigo and violet lightwaves) to be a first reflected light L1, and allowing another part of the incident light to transmit therethrough. The second metallic layer 140 is capable of reflecting part of the transmitted light to be a second reflected light L2, and allowing another part of the transmitted light to transmit therethrough. The third metallic layer 160 is capable of reflecting at least part of the transmitted light to be a third reflected light L3. The light absorbing layer 170 is capable of absorbing any light that is transmitted from the third metallic layer 160. The first reflected light L1, the second reflected light L2 and the third reflected light L3 are fundamentally derived from a same incident light on the multi-layer film 100, and thus have the possibility of interfering with each other. Due to the material of the first metallic layer 120, the second metallic layer 140 and the third metallic layer 160 being the same, the first reflected light L1, the second reflected light L2 and the third reflected light L3 have almost the same vibration direction, thus facilitating any such interference. The higher the reflection capability of the material of the first, second and third metallic layers 120, 140, 160, the higher the intensity of the first reflected light L1, the second reflected light L2 and the third reflected light L3.

The first medium layer 130 is sandwiched between the first metallic layer 120 and the second metallic layer 140. The second medium layer 150 is sandwiched between the second metallic layer 140 and the third metallic layer 160. Each of the first medium layer 130 and the second medium layer 150 is transparent, and each contains a material selected from a group consisting of silicon dioxide (SiO₂), titanium oxide (TiO₂), niobium pentoxide (Nb₂O₅), aluminum oxide (Al₂O₃), and magnesium fluoride (MgF₂). In certain embodiments, each of the first medium layer 130 and the second medium layer 150 is made of the material selected from the group consisting of SiO₂, TiO₂, Nb₂O₅, Al₂O₃, and MgF₂. A thickness of each of the first medium layer 130 and the second medium layer 150 can be in a range from 50 nm to 1000 nm. The thickness of the first medium layer 130 impacts a light path difference between the first reflected light L1 and the second reflected light L2. The thickness of the second medium layer 150 impacts a light path difference between the second reflected light L2 and the third reflected light L3. With this configuration, the first medium layer 130 and the second medium layer 150 control light path differences between the first reflected light L1, the second reflected light L2, and the third reflected light L3, such that the first reflected light L1, the second reflected light L2 and the third reflected light L3 interfere with each other on the multi-layer film 100 to produce a desired color appearance of the multi-layer film 100.

When the light path difference between any two of the first reflected light L1, the second reflected light L2 and the third reflected light L3 is an even multiple of half of a central wavelength of a particular color lightwave of the visible light, that color lightwave is enhanced. Under this condition, the multi-layer film 100 (and also the entire multi-layer film structure) appears to have a color substantially that of a mixture of the enhanced color lightwaves produced by the interferences between the first reflected light L1, the second reflected light L2 and the third reflected light L3. In one example, among the color lightwaves of visible light, i.e., red, orange, yellow, green, blue, indigo and violet, two of these color lightwaves may be enhanced in interferences between each two of the first reflected light L1, the second reflected light L2 and the third reflected light L3. For instance, red and green lightwaves may both be enhanced. In such example, the interferences give the multi-layer film 100 a color appearance comprised of a mixture of red and green; i.e., yellow.

In an alternative embodiment, the third metallic layer 160 can be configured to transmit little or no light therethrough. That is, the third metallic layer 160 can have very high reflectivity or be a total reflection layer. In such case, the light absorbing layer 170 can be omitted.

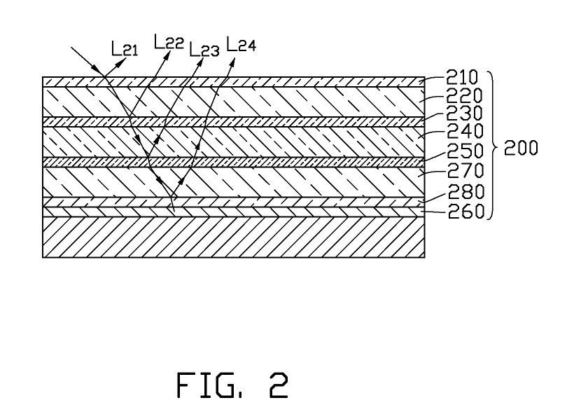

Referring to FIG. 2, an exemplary multi-layer film 200 in accordance with a second embodiment is shown. The multi-layer film 200 is similar in principle to the multi-layer film 100 described above. However, the multi-layer film 200 includes in sequence a first metallic layer 210, a first medium layer 220, a second metallic layer 230, a second medium layer 240, a third metallic layer 250, a third medium layer 270, a fourth metallic layer 280, and a light absorbing layer 260. The first metallic layer 210, the second metallic layer 230, the third metallic layer 250 and the fourth metallic layer 280 are capable of reflecting incident light and allowing another part of the incident light to transmit therethrough to produce a first reflected light L21, a second reflected light L22, a third reflected light L23, and a fourth reflected light L24, respectively. Interferences occur between the first reflected light L21, the second reflected light L22, the third reflected light L23 and the fourth reflected light L24 to produce a desired color appearance of the multi-layer film 200.

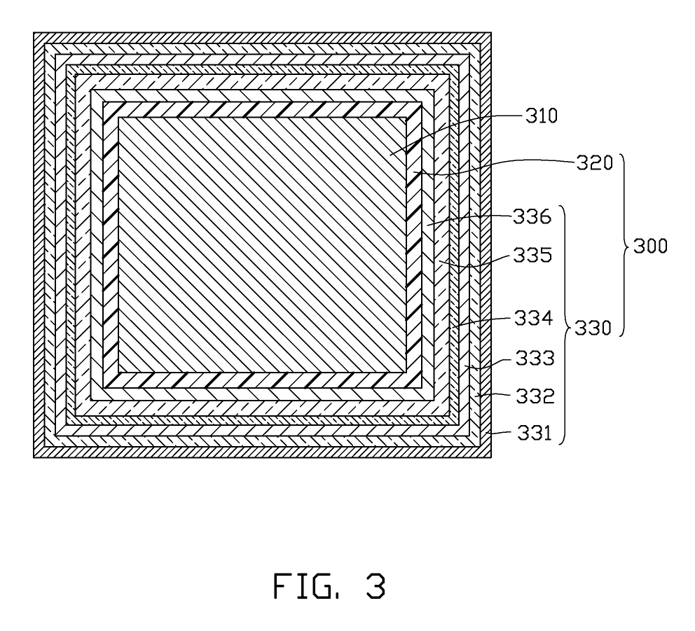

Referring to FIG. 3, a shell 300 of an electronic device 310 is provided as an exemplary embodiment of an application environment of a multi-layer film 330. The shell 300 includes an enclosure 320 configured as a substrate, and the multi-layer film 330 formed on the enclosure 320. In the illustrated embodiment, the multi-layer film 330 includes in sequence from outside to inside a first metallic layer 331, a first medium layer 332, a second metallic layer 333, a second medium layer 334, a third medium layer 335 and a light absorbing layer 336. The multi-layer film 330 is configured to give the shell 300 a desired color appearance.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. A multi-layer film for coating a substrate, the multi-layer film comprising:
a first metallic layer configured for reflecting part of incident ambient light to be a first reflected light and allowing another part of the incident ambient light to transmit therethrough to be a first transmitted light;
a second metallic layer configured for reflecting part of the first transmitted light to be a second reflected light and allowing another part of the first transmitted light to transmit therethrough to be a second transmitted light;
a reflecting layer configured for reflecting at least part of the second transmitted light to be a third reflected light;
a first transparent medium layer sandwiched between the first metallic layer and the second metallic layer; and
a second transparent medium layer sandwiched between the second metallic layer and the reflecting layer, wherein the first medium layer is configured for controlling a light path difference between the first reflected light and the second reflected light, and the second medium layer is configured for controlling a light path difference between the second reflected layer and the third reflected layer, thereby allowing the first reflected light, the second reflected light and the third reflected light to interfere with each other and provide the multi-layer film with a desired color appearance.

2. The multi-layer film as described in claim 1, further comprising a light absorbing layer adjacent to the reflecting layer at a side of the reflecting layer opposite to the second medium layer and configured to cling to the substrate, the reflecting layer being metallic and configured for reflecting part of the second transmitted light to be the third reflected light and allowing another part of the second transmitted light to transmit therethrough to be a third transmitted light, the light absorbing layer being configured for absorbing the third transmitted light transmitted from the reflecting layer.

3. The multi-layer film as described in claim 2, wherein the first metallic layer, the second metallic layer and the reflecting layer comprise a same material selected from the group consisting of aluminum, nickel, chromium, and alloy of nickel and chromium.

4. The multi-layer film as described in claim 1, wherein a thickness of each of the first metallic layer, the second metallic layer and the reflecting layer is in a range from 0.3 nm to 200 nm.

5. The multi-layer film as described in claim 1, wherein the first and second medium layers each comprise material selected from the group consisting of silicon dioxide, titanium oxide, niobium oxide, aluminum oxide and magnesium fluoride.

6. The multi-layer film as described in claim 1, wherein a thickness of each of the first medium layer and the second medium layer is in a range from 50 nm to 1000 nm.

7. A multi-layer film, comprising:
a light absorbing layer;
a plurality of metallic layers formed over the light absorbing layer; and
a plurality of transparent medium layers each sandwiched between two respective adjacent of the metallic layers;
wherein each of the metallic layers is configured for reflecting part of light incident thereon to be a reflected light and transmitting another part of the incident light therethrough, the light absorbing layer is capable of absorbing light incident thereon, and the medium layers are configured for controlling light path differences between the reflected lights thereby allowing the reflected lights to interfere with each other and give the multi-layer film a predetermined color appearance.

8. The multi-layer film as described in claim 7, wherein the metallic layers comprise a same material selected from the group consisting of aluminum, nickel, chromium, and alloy of nickel and chromium.

9. The multi-layer film as described in claim 7, wherein a thickness of each of the first metallic layer, the second metallic layer and the third metallic layer is in a range from 0.3 nm to 200 nm.

10. The multi-layer film as described in claim 7, wherein the medium layers each comprise material selected from the group consisting of silicon dioxide, titanium oxide, niobium oxide, aluminum oxide and magnesium fluoride.

11. The multi-layer film as described in claim 7, wherein a thickness of each of the medium layers is in a range from 50 nm to 1000 nm.

12. An electronic device shell, comprising:
an enclosure;
a light absorbing layer adhering to the enclosure;
a plurality of metallic layers formed over the light absorbing layer; and
a plurality of transparent medium layers each sandwiched between two respective adjacent of the metallic layers, wherein each of the metallic layers is configured for reflecting part of incident light to be a reflected light and transmitting another part of the incident light therethrough, the light absorbing layer is capable of absorbing light incident thereon, and the medium layers are configured for controlling light path differences between the reflected lights such that the reflected lights interfere with each other and provide the electronic device shell with a desired color appearance.

13. The electronic device shell as described in claim 12, wherein the metallic layers comprise a same material selected from the group consisting of aluminum, nickel, chromium, and alloy of nickel and chromium.

14. The electronic device shell as described in claim 12, wherein a thickness of each of the first metallic layer, the second metallic layer and the third metallic layer is in a range from 0.3 nm to 200 nm.

15. The electronic device shell as described in claim 12, wherein the medium layers each comprise material selected from the group consisting of silicon dioxide, titanium oxide, niobium oxide, aluminum oxide and magnesium fluoride.

16. The electronic device shell as described in claim 12, wherein a thickness of each of the medium layers is in a range from 50 nm to 1000 nm.
